(19) United States
(12) Patent Application Publication
(10) Pub. No.: US 2013/0233685 A1
(43) Pub. Date: Sep. 12, 2013

(54) PRESS KEY

(71) Applicant: Qing Zhang, Changshu (CN)

(72) Inventor: Qing Zhang, Changshu (CN)

(21) Appl. No.: 13/413,211

(22) Filed: Mar. 6, 2012

(51) Int. Cl. H01H 13/50

(52) U.S. Cl. 200/344; 200/341

(57) ABSTRACT

A press key includes: a keycap movable with respect to a base unit; and a magnetic restoring device including a first magnetic member connected to the keycap and disposed between the base unit and the keycap, and a second magnetic member disposed on the base unit. The first and second magnetic members produce a repulsive force therebetween to move the keycap away from the base unit.

### BACKGROUND OF THE INVENTION

1. Field of the Invention

This invention relates to a press key, more particularly to a press key including a magnetic restoring device.

2. Description of the Related Art

A press key can be used in a computer keyboard or a telephone keyboard. As shown in FIGS. 1 and 2, a conventional press key includes a keycap 1, a bordering member 11, a contact 2, a restoring device 3, and a base unit 4 that has a substrate 41 and a circuit module 411 formed on the substrate 41.

The bordering member 11 is connected to the base unit 4. The keycap 1 is spaced apart and extends outwardly from the bordering member 11. The keycap 1 and the base unit 4 cooperatively define a space 10 therebetween.

The restoring device 3 is disposed in the space 10, and includes an elastic member 31 and two levers 32 that are pivotally connected to each other. The elastic member 31 is connected to the keycap 1 and is made of rubber in a form of a bowl-shape. The elastic member 31 may be replaced by a restoring spring. The two levers 32 constitute a scissors-type linkage assembly and are connected between the base unit 4 and the keycap 1. The contact 2 extends from the bowl-shaped elastic member 31. When an external force is applied to press the keycap 1 toward the base unit 4, the elastic member 31 is deformed so that the contact 2 is moved to contact the circuit module 411 to produce a signal (see FIG. 2). When the external force is released, the deformed elastic member 31 returns to its original state due to its restoring force, thereby moving the two levers 32, the contact 2 and the keycap 1 away from the base unit 4 (see FIG. 1).

However, in order to achieve the state-restoring function of the restoring device 3, the elastic member 31 should be formed to have a sufficient volume to provide enough restoring force to move the keycap 1, the levers 32 and the contact 2 away from the base unit 4. In order to meet the volume requirement of the elastic member 31, the conventional press key usually cannot satisfy the trend toward miniaturization of electronic devices. Moreover, elastic fatigue problem of the elastic member 31 is likely to occur after a long period of service time.

### SUMMARY OF THE INVENTION

Therefore, an object of the present invention is to provide a press key that can overcome the aforesaid drawbacks associated with the prior art.

Accordingly, a press key of this invention comprises:

a base unit;

a keycap movable with respect to the base unit; and

a magnetic restoring device including a first magnetic member connected to the keycap and disposed between the base unit and the keycap, and a second magnetic member disposed on the base unit, the first and second magnetic member producing a repulsive force therebetween to move the keycap away from the base unit.

### BRIEF DESCRIPTION OF THE DRAWINGS

Other features and advantages of the pre sent invention will become apparent in the following detailed description of the preferred embodiments of the invention, with reference to the accompanying drawings, in which:

FIG. 1 is a cross-sectional view of a conventional press key;

FIG. 2 is a cross-sectional view illustrating the press key of FIG. 1 in a pressed state;

FIG. 3 is a cross-sectional view of the first preferred embodiment of a press key according to this invention;

FIG. 4 is a cross-sectional view illustrating the press key of FIG. 3 in a pressed state;

FIG. 5 is a cross-sectional view of the second preferred embodiment of a press key according to this invention; and

FIG. 6 is a cross-sectional view illustrating the press key of FIG. 5 in a pressed state.

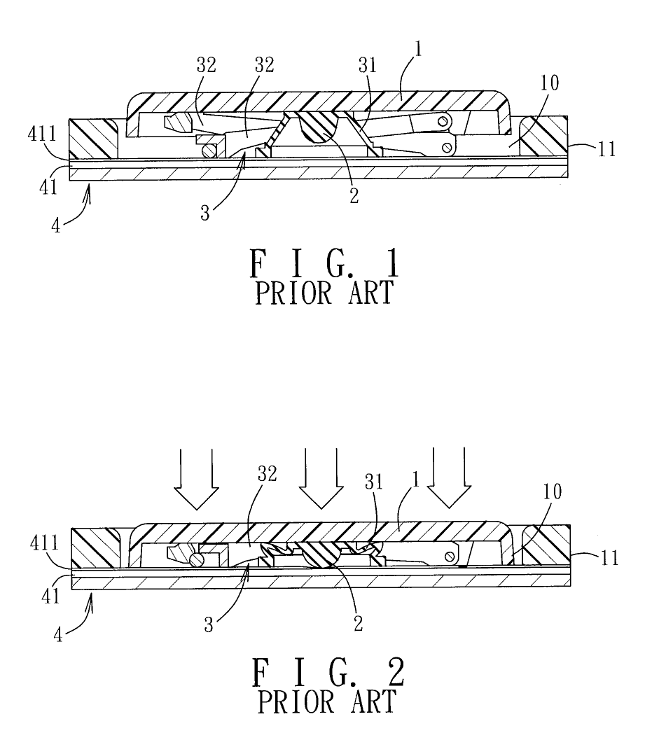

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

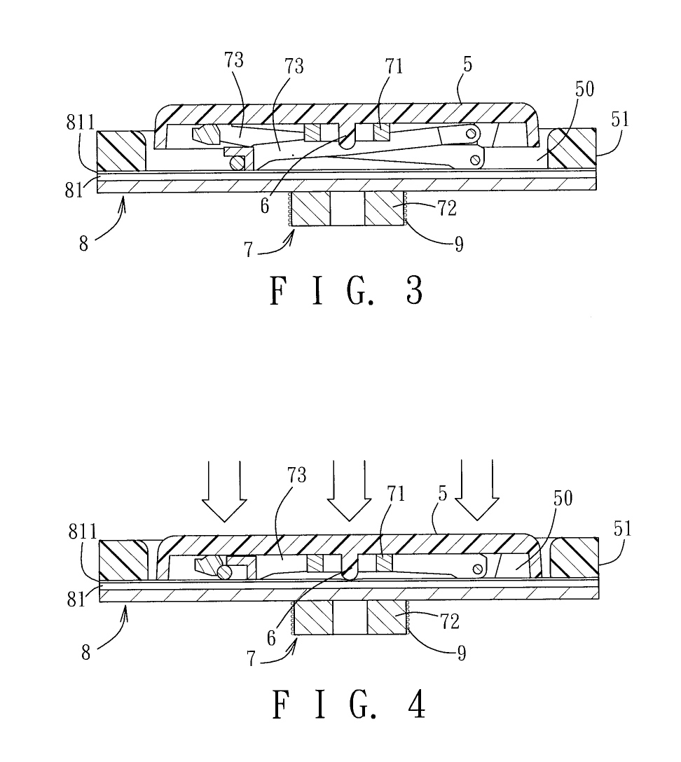

Referring to FIGS. 3 and 4, the first preferred embodiment of a press key according to this invention includes a keycap 5, a bordering member 51, a contact 6, a magnetic restoring device 7 and a base unit 8, and is adapted to be used in a computer keyboard or a telephone keyboard. The base unit 8 includes a substrate 81 and a circuit module 811 that is formed on the substrate 81 and that is capable of generating an electrical signal.

The bordering member 51 extends upwardly from the base unit 8. The keycap 5 is movable with respect to the base unit 8. In this embodiment, the keycap 5 is movably connected to the base unit 8. For convenient and stable pressing operation, the keycap 5 is preferably cap-shaped and extends outwardly from the bordering member 51 in a normal state (FIG. 3).

The contact 6 extends from the keycap 5 and is disposed in a space 50 between the keycap 50 and the base unit 8. When the keycap 5 is pressed, the contact 6 is moved to contact the circuit module 811 of the base unit 8 to produce the electrical signal (FIG. 4). In this embodiment, the circuit module 811 is a membrane circuit board, but is not limited thereto. For example, a printed circuit board having touch switches may also be used. In this embodiment, the contact 6 and the keycap 5 are formed in one-piece.

The magnetic restoring device 7 includes first and second magnetic members 71, 72, and two levers 73. The first magnetic member 71 is connected to the keycap 5 and is disposed in the space 50 between the base unit 8 and the keycap 5. The second magnetic member 72 is disposed on a lower surface of the substrate 81 of the base unit 8 in a position corresponding to that of the first magnetic member 71. The two levers 73 are pivotally connected to each other to constitute a scissors-type linkage assembly that is connected to the base unit 8 and the keycap 5. Since the scissors type-linkage assembly is well-known in the relevant art, a detailed description thereof is omitted herein for the sake of brevity.

The first and second magnetic members 71, 72 have the same polarity, and thus, a repulsive force is formed between the first and second magnetic members 71, 72, to move the keycap 5 along with the contact 6 away from the base unit 8, thereby rendering the contact 6 to not contact the circuit module 811 (see FIG. 3). As shown in FIG. 4, when an external force is applied to press the keycap 5 toward the base unit 8, the contact 6 is also moved to contact the circuit module 811 to produce the electrical signal. After the external force is released, the keycap 5 and the contact 6 are moved to the original position (FIG. 3) due to the repulsive force between the first and second magnetic members 71, 72.

In the first preferred embodiment, the first magnetic member 71 is a permanent magnet, and the second magnetic member 72 is an electromagnet that is electrically connected to the base unit 8 and that has spiral coils 9. By applying electricity to the second magnetic member 72 from the base unit 8, the second magnetic member 72 can produce the same polarity as that of the first magnetic member 71, thereby forming the repulsive force. When no power is supplied to the press key, no repulsive force is produced, and the keycap 5 moves toward the base unit 8 and stays at the position shown in FIG. 4. Therefore, the total thickness of the press key could be reduced, which is beneficial for storage of a product having the press key of this invention.

Alternatively, each of the first and second magnetic members 71, 72 may be the permanent magnet, the electromagnet, or any other article that can produce magnetism.

Because the magnetic members 71, 72 are used as the position restoring device, the volume requirement and the elastic fatigue problem for the conventional elastic member 31 could be eliminated in this invention. Thus, the sizes, thickness, and materials of the keycap 5 and the contact 6 are not limited, and can be adjusted to meet the requirement of cost reduction. In addition, when pressing the keycap 5, it is only necessary to overcome the repulsive force between the first and second magnetic members 71, 72, and thus, pressing of the keycap 5 is more effortless as compared to the prior art.

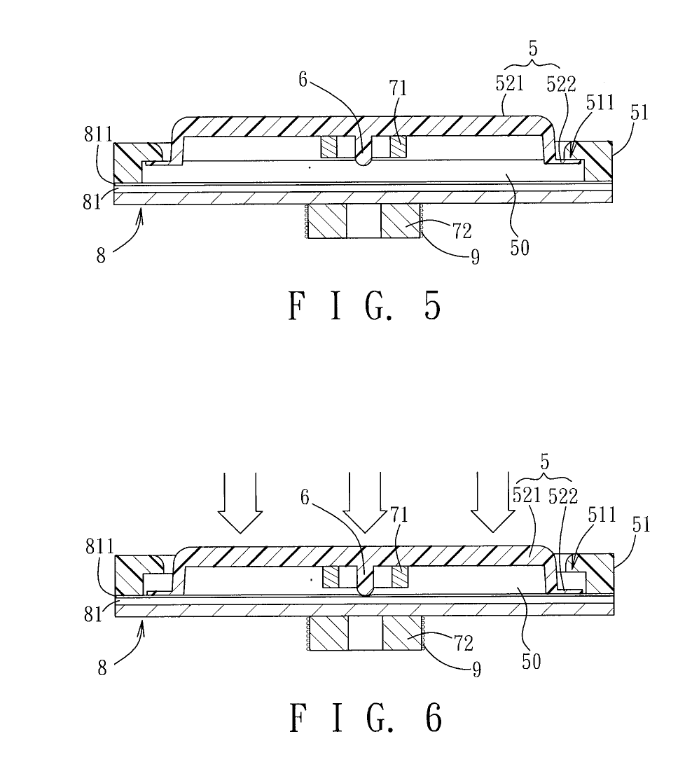

FIGS. 5 and 6 show the second preferred embodiment of a press key according to this invention. The second preferred embodiment differs from the first preferred embodiment in that: (1) the scissors-type linkage assembly (i.e., the two levers 73) are dispensed with; (2) the bordering member 51 extends from the base unit 8 to be disposed above the base unit 8 and has a bent end portion 511 that is bent toward the keycap 5; and (3) the keycap 5 has a cap body 521 and a flange portion 522. The flange portion 522 extends outwardly and annularly from an end portion of the cap body 521, and is movably disposed between the base unit 8 and the bent end portion 511. With the bent end portion 511 and the flange portion 522, the keycap 5 can be restricted in position between the base unit 8 and the bent end portion 511 of the bordering member 51 without the scissors-type linkage assembly, thereby simplifying the structure and reducing production costs of the press key.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A press key comprising:
a base unit;
a keycap movable with respect to said base unit; and
a magnetic restoring device including a first magnetic member connected to said keycap and disposed between said base unit and said keycap, and a second magnetic member disposed on said base unit, said first and second magnetic members producing a repulsive force therebetween to move said keycap away from said base unit.

2. The press key of claim 1, wherein each of said first and second magnetic members is selected from a permanent magnet and an electromagnet that is electrically connected to said base unit.

3. The press key of claim 1, wherein said first magnetic member is a permanent magnet, and said second magnetic member is an electromagnet that is electrically connected to said base unit.

4. The press key of claim 1, further comprising a contact extending from said keycap and disposed between said keycap and said base unit, said contact being movable to contact said base unit for producing an electrical signal when said keycap is pressed.

5. The press key of claim 4, further comprising a bordering member disposed above said base unit and having a bent end portion that is bent toward said keycap, said keycap having a flange portion that is movably disposed between said base unit and said bent end portion.

6. The press key of claim 4, wherein said contact and said keycap are formed in one-piece.

7. The press key of claim 4, wherein said magnetic restoring device further includes a scissors-type linkage assembly connected to said base unit and said keycap.
